(19) United States
(12) Patent Application Publication
(10) Pub. No.: US 2025/0168677 A1
(43) Pub. Date: May 22, 2025

(54) ASSISTANCE INFORMATION FOR MEASUREMENT GAPS

(71) Applicant: QUALCOMM Incorporated, San Diego, CA (US)

(72) Inventors: Diana MAAMARI, San Diego, CA (US); Valentin Alexandru GHEORGHIU, Yokohama-shi (JP); Mickael MONDET, Louannec (FR); Hyun Yong LEE, San Diego, CA (US); Prashanth Haridas HANDE, San Diego, CA (US); Carlos CABRERA MERCADER, Cardiff, CA (US); Mouaffac AMBRISS, San Diego, CA (US)

(21) Appl. No.: 18/517,534

(22) Filed: Nov. 22, 2023

(51) Int. Cl. H04W 24/10; H04W 24/08

(52) U.S. Cl. CPC H04W 24/10; H04W 24/08

(57) ABSTRACT

Various aspects of the present disclosure generally relate to wireless communication. Some aspects relate generally to measurement gaps and to a user equipment (UE) transmitting assistance information for measurement gaps. In some aspects, the assistance information may facilitate an activation or a deactivation of one or more measurement gap occasions. In some aspects, the assistance information may indicate one or more conditions associated with configured measurement gap occasions. In some aspects, the assistance information may include, or may be included in, status information for the UE, such as a buffer status report or a delay status report, among other examples. In some aspects, the UE may be configured with a delay factor for measurement gaps.

### FIELD OF THE DISCLOSURE

Aspects of the present disclosure generally relate to wireless communication and specifically, to techniques and apparatuses associated with assistance information for measurement gaps.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A measurement gap is a scheduled time gap in which a UE may perform neighbor cell measurements (for example, inter-frequency neighbor cell measurements and/or intra-frequency neighbor cell measurements). The UE may not be permitted to transmit or receive data from the current serving cell during a measurement gap. For example, a UE that is configured with measurement gaps may not schedulable during the measurement gaps (for example, a network node may not schedule uplink communications or downlink communications during a measurement gap). The measurement gaps may have a higher priority than data traffic. In some examples, measurement gaps may delay data transfer between a UE and a network, which may be undesirable for delay critical traffic, such as extended reality (XR) traffic or ultra-reliable low latency communications (URLLC) traffic, among other examples. The delay due to measurement gaps may be particularly severe for XR traffic, because measurement gaps may have an increased likelihood of overlapping with XR traffic (as compared to other types of traffic). XR is an umbrella term encapsulating augmented reality (AR), virtual reality (VR), mixed reality (MR), or any combination thereof. In some examples, a traffic pattern for multimedia traffic (for example, XR traffic) may include data bursts with a non-integer periodicity. In some examples, the mismatch between the integer periodicity of the measurement gaps and the non-integer periodicity of the multimedia traffic may result in multimedia burst traffic that overlaps with the measurement gap in one or more measurement gap occasions.

### SUMMARY

In some aspects, an apparatus for wireless communication at a user equipment (UE) includes one or more memories storing processor-executable code. The apparatus may include one or more processors coupled with the one or more memories. At least one processor of the one or more processors may be configured to cause the UE to transmit, to a network node, assistance information associated with measurement gaps, the assistance information indicating at least one of one or more conditions or status information. At least one processor of the one or more processors may be configured to cause the UE to receive, from the network node, a communication associated with a measurement gap configuration, the communication being associated with the assistance information.

In some aspects, an apparatus for wireless communication at a network node includes one or more memories storing processor readable code. The apparatus may include one or more processors coupled with the one or more memories. At least one processor of the one or more processors may be configured to cause the network node to receive assistance information associated with a UE, the assistance information being associated with measurement gaps, and the assistance information indicating at least one of one or more conditions or status information. At least one processor of the one or more processors may be configured to cause the network node to transmit a communication, for the UE, associated with a measurement gap configuration, the communication being associated with the assistance information.

In some aspects, a method of wireless communication performed at a UE includes transmitting, to a network node, assistance information associated with measurement gaps, the assistance information indicating at least one of one or more conditions or status information; and receiving, from the network node, a communication associated with a measurement gap configuration, the communication being associated with the assistance information.

In some aspects, a method of wireless communication performed at a network node includes receiving assistance information associated with a UE, the assistance information being associated with measurement gaps, and the assistance information indicating at least one of one or more conditions or status information; and transmitting a communication, for the UE, associated with a measurement gap configuration, the communication being associated with the assistance information.

In some aspects, a non-transitory computer-readable medium storing a set of instructions for wireless communication includes one or more instructions that, when executed by one or more processors of a UE, cause the UE to: transmit, to a network node, assistance information associated with measurement gaps, the assistance information indicating at least one of one or more conditions or status information; and receive, from the network node, a communication associated with a measurement gap configuration, the communication being associated with the assistance information.

In some aspects, a non-transitory computer-readable medium storing a set of instructions for wireless communication includes one or more instructions that, when executed by one or more processors of a network node, cause the network node to: receive assistance information associated with a UE, the assistance information being associated with measurement gaps, and the assistance information indicating at least one of one or more conditions or status information; and transmit a communication, for the UE, associated with a measurement gap configuration, the communication being associated with the assistance information.

In some aspects, an apparatus for wireless communication includes means for transmitting, to a network node, assistance information associated with measurement gaps, the assistance information indicating at least one of one or more conditions or status information; and means for receiving, from the network node, a communication associated with a measurement gap configuration, the communication being associated with the assistance information.

In some aspects, an apparatus for wireless communication includes means for receiving assistance information associated with a UE, the assistance information being associated with measurement gaps, and the assistance information indicating at least one of one or more conditions or status information; and means for transmitting a communication, for the UE, associated with a measurement gap configuration, the communication being associated with the assistance information.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example of a measurement gaps for radio resource management (RRM) measurements.

FIG. 4 is a diagram of an example of operations associated with assistance information for measurement gaps.

FIG. 5 is a diagram of an example of a delay factor associated with measurement gaps.

FIG. 6 is a flowchart illustrating an example process performed, for example, at a UE or an apparatus of a UE that supports operations associated with assistance information for measurement gaps.

FIG. 7 is a flowchart illustrating an example process performed, for example, at a network node or an apparatus of a network node that supports operations associated with assistance information for measurement gaps.

FIG. 8 is a diagram of an example apparatus for wireless communication that supports operations associated with assistance information for measurement gaps.

FIG. 9 is a diagram of an example apparatus for wireless communication that supports operations associated with assistance information for measurement gaps.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

When a user equipment (UE) moves within a current serving cell for the UE and triggers a mobility event (for example, an A2 mobility event, an A3 mobility event, or another mobility event defined or otherwise fixed by a wireless communication standard, such as the 3GPP), a network node may configure the UE to perform measurements on candidate neighbor cells. In some examples, the UE may be configured to perform measurements on candidate neighbor cells operating on different frequencies from the current serving cell for the UE. Measurements on neighbor cells with different frequencies from the current serving cell may be referred to as “inter-frequency neighbor cell measurements.” The UE may be configured with measurement gaps to perform the inter-frequency neighbor cell measurements. Additionally or alternatively, the UE may be configured to perform measurements on candidate neighbor cells operating on the same frequencies (for example, a same frequency band) as the current serving cell for the UE. Measurements on neighbor cells with the same frequencies as the current serving cell may be referred to as “intra-frequency neighbor cell measurements.” The UE may be configured with measurement gaps to perform the intra-frequency neighbor cell measurements. A measurement gap is a scheduled time gap in which the UE may perform neighbor cell measurements (for example, inter-frequency neighbor cell measurements and/or intra-frequency neighbor cell measurements). The UE may not be permitted to transmit or receive data from the current serving cell during a measurement gap.

In some examples, measurement gaps may delay data transfer between a UE and a network node (for example, downlink data from the network node to the UE and/or uplink data from the UE to the network node), which may be undesirable for delay critical traffic, such as extended reality (XR) traffic or ultra-reliable low latency communications (URLLC) traffic, among other examples. The delay due to measurement gaps may be particularly severe for XR traffic, because measurement gaps may have an increased likelihood of overlapping with XR traffic (as compared to other types of traffic).

As described elsewhere herein, the UE (or more specifically for example, a MAC entity of the UE) may not receive on the DL-SCH (for example, the physical downlink shared channel (PDSCH)) during a measurement gap (for example, during a measurement gap occasion). As a result, the measurement gaps may introduce scheduling restrictions for multimedia traffic because the measurement gaps may interrupt the transmission or reception of the multimedia traffic (for example, of XR traffic). For example, a transmission time (for example, an amount of time associated with a transmission of one or more packets) may be increased for some multimedia traffic bursts due to an overlap in the time domain with a measurement gap occasion. As a result, latency associated with the multimedia traffic may be increased (for example, because of the increased transmission time), negatively impacting the multimedia traffic.

Such delays or increased latency may not satisfy latency requirements for delay critical traffic, such as XR traffic or multimedia traffic. For example, XR applications (for example, AR, VR, and/or MR applications) may experience significant lag due to such delays in XR traffic. Mobility measurements or radio resource measurements (RRM) (for example, neighbor cell measurements) may be important for the overall performance of a UE, and ignoring mobility measurements may adversely affect the performance of the UE. However, as described elsewhere herein, measurement gaps may delay data transfer, which may be undesirable for delay sensitive traffic (for example, multimedia traffic, XR traffic, and/or URLLC traffic, among other examples). For example, such delays may cause the delivery of delay critical traffic to not satisfy latency requirements and/or quality of service (QOS) requirements associated with the delay sensitive traffic.

In some examples, the network node may transmit, and the UE may receive, an indication to activate or deactivate a measurement gap (for example, one or more measurement gap occasions). For example, the network node may dynamically activate and/or deactivate one or more measurement gap occasions to avoid the scheduling restrictions described elsewhere herein. In some examples, the network node may transmit, and the UE may receive, a medium access control (MAC) control element (MAC-CE) communication or a downlink control information (DCI) communication that activates or deactivates one or more measurement gap occasions. For example, for a UE configured with inter-frequency measurement gaps, the network node can signal the UE to skip one or more measurement gap (for example, to avoid scheduling restrictions).

As an example, an indication to deactivate or skip a measurement gap may cause multimedia traffic or XR traffic to have a higher priority than the measurement gap. As a result, the UE may transmit or receive the multimedia traffic or XR traffic during the measurement gap (for example, rather than refraining from transmit or receive the multimedia traffic or XR traffic during the measurement gap). This may enable the UE to transmit or receive the multimedia traffic or XR traffic during without the interruption, increased latency, and/or delays caused by the measurement gap(s). An indication to activate or resume the use of a measurement gap may cause a priority of the measurement gap(s) to be restored (for example, such that the measurement gap(s) have a higher priority than the shared channel communications, such as XR communications). For example, the network node may transmit, and the UE may receive, an indication to restore the high priority for one or more measurement gap occasions (for example, a next measurement gap occasion) to cause the UE to perform one or more measurements during the one or more measurement gap occasions (for example, rather than transmitting or receiving traffic).

Therefore, the network node may dynamically activate or deactivate one or more measurement gap occasions. This may enable the network node and the UE to communicate delay sensitive traffic (such as multimedia traffic or XR traffic) when the UE is configured with a measurement gap configuration with a reduced likelihood of interruption or delay to the delay sensitive traffic that may otherwise be caused by one or more measurement gaps. Additionally, the network node may dynamically cause the UE to perform measurements during one or more measurement gap occasions, such as when a measurement gap procedure may be beneficial (for example, where the UE is experiencing poor radio frequency (RF) conditions or has a risk of a radio link failure).

However, the network node may have incomplete information for whether measurement gaps should be activated or deactivated. For example, the UE may have uplink data to transmit (for example, with different priority values), may be moving (for example, at a given speed), and/or may be experiencing different delays on certain logical channels, among other examples. This information may impact the delay experienced by the UE, may impact an arrival time of data at the UE, may indicate an impact of activating or deactivating one or more measurement gap occasions, and/or may otherwise influence whether measurement gaps should be activated or deactivated. Because the network node may not have access to such information when activating or deactivating a given measurement gap occasion, the activation or deactivation of the given measurement gap occasion may be suboptimal. For example, the network node may activate a measurement gap occasion, resulting in increased latency for uplink data to be transmitted by the UE. As another example, the network node may deactivate a measurement gap occasion when the UE is in a high mobility scenario (for example, is moving at a high speed), increasing the likelihood of a radio link failure caused by the UE moving outside of a coverage area of the network node without having performed sufficient inter-frequency or intra-frequency measurements (for example, to indicate a neighbor cell for handover).

Various aspects relate generally to measurement gaps and to assistance information for measurement gaps. In some aspects, the assistance information may facilitate an activation or a deactivation of one or more measurement gap occasions.

In some aspects, the assistance information may indicate one or more conditions associated with configured measurement gap occasions. For example, the one or more conditions may define scenarios and/or limitations associated with measurement gaps occasions during which the UE is expected to perform one or more measurements. For example, the assistance information may indicate an amount of time between measurement gap occasions that is supported by the UE. Additionally or alternatively, the assistance information may indicate uplink delay information, such as whether an uplink delay experienced by the UE (for example, a delay in data to be transmitted by the UE) satisfies a delay threshold.

In some aspects, the UE may receive an indication of one or more aperiodic measurement gaps. For example, a network node may configure or indicate one or more aperiodic measurement gaps using, based on, or otherwise associated with the assistance information. For example, the network node may indicate one or more aperiodic measurement gap occasions to cause the aperiodic measurement gap occasions to not overlap, in the time domain, with a transmission of XR traffic (for example, based on the traffic pattern or profile associated with the XR traffic indicated at least in part by the assistance information).

In some aspects, the assistance information may include, or may be included in, a buffer status report. Additionally or alternatively, the assistance information may include, or may be included in, a delay status report. For example, a transmission of a buffer status report and/or a delay status report may be triggered if the UE is configured with a measurement gap configuration and/or the UE detects a measurement event, such as an A2 measurement event (for example, where a signal strength of a serving cell of the UE does not satisfy a threshold).

In some aspects, the UE may be configured with a delay factor for measurement gaps. The delay factor may be associated with multimedia traffic flows or XR traffic flows. For example, the delay factor may be applicable when a multimedia traffic flow or an XR traffic flow is being communicated between the UE and the network node. In some aspects, the delay factor may indicate a delay in a start of one or more measurement gap occasions (or a start of a measurement period for one or more measurement gap occasions). In some aspects, the delay factor may be a scaling factor associated with scaling a length of one or more measurement gap occasions. The delay factor may be based on a traffic pattern of a multimedia traffic flow or an XR between the UE and the network node.

Particular aspects of the subject matter described in this disclosure can be implemented to realize one or more of the following potential advantages. In some examples, the described techniques can be used to improve an activation or deactivation for measurement gap occasions. For example, by the UE transmitting the assistance information to the network node, the network node may use uplink traffic flow information (for example, that may have otherwise been unavailable to the network node) to activate, deactivate, or modify one or more measurement gap occasions.

For example, by the UE transmitting a buffer status report in associated with a measurement gap occasion, the network node may obtain an indication of whether the UE has uplink data to transmit that may be scheduled during the measurement gap occasion. By the UE transmitting a delay status report associated with a measurement gap occasion, the network node may obtain information indicative of a delay budget of the uplink data to be transmitted by the UE (for example, enabling the network node to deactivate an upcoming measurement gap occasion if the UE has uplink data with a small remaining delay budget, thereby improving a likelihood that the UE transmits the uplink data within the remaining delay budget).

In some aspects, by using one or more aperiodic measurement gaps, a likelihood that a measurement gap and a transmission of shared channel data (for example, XR data or other data) overlap in the time domain may be reduced. For example, using the assistance information, the network node may be enabled to configure the one or more aperiodic measurement gaps around a pattern of XR data.

In some aspects, by applying the delay factor to one or more measurement gaps, the UE may delay when measurements are performed by the UE, rather than skip performing measurements. This may reduce a likelihood of a measurement gap occasion causing an interruption or delay to a transmission or reception of shared channel data (for example, XR data) while still enabling the UE to perform one or more measurements during the measurement gap occasion.

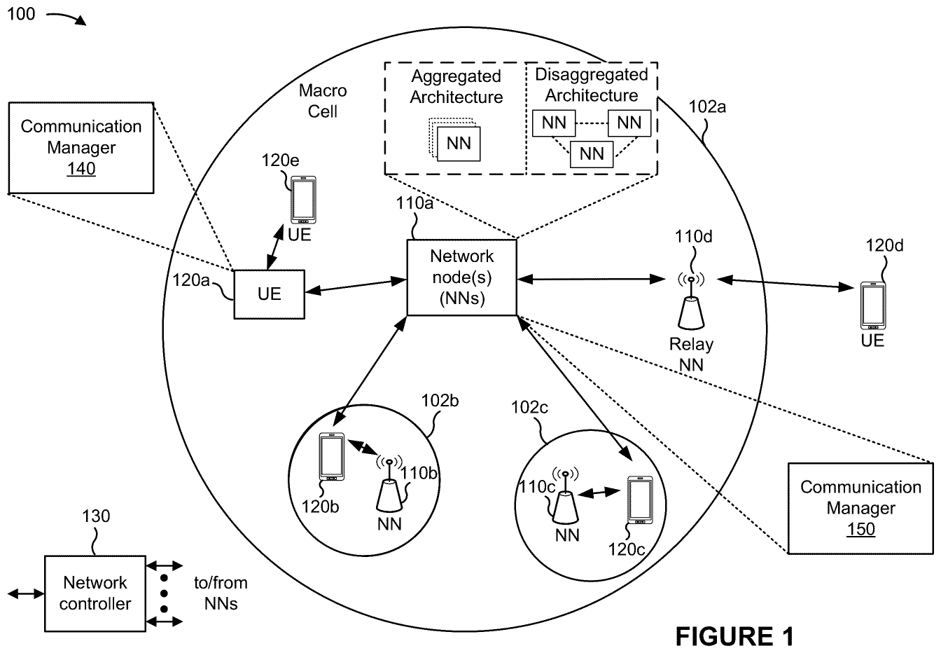

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or XR headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 120a and 120e) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol using for example a PC5 interface for direct communication, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110. In other examples, the two or more UEs 120 may communicate through a vehicle-to-network-vehicle (V2N2V) protocol for example by communicating through a Uu interface using the LTE and/or NR uplink and downlink.

In some aspects, the UE 120 may include a communication manager 140. As described in more detail elsewhere herein, the communication manager 140 may transmit, to a network node, assistance information associated with measurement gaps, the assistance information indicating at least one of one or more conditions or status information; and receive, from the network node, a communication associated with a measurement gap configuration, the communication being associated with the assistance information. Additionally or alternatively, the communication manager 140 may perform one or more other operations described herein.

In some aspects, the network node 110 may include a communication manager 150. As described in more detail elsewhere herein, the communication manager 150 may receive assistance information associated with a UE, the assistance information being associated with measurement gaps, and the assistance information indicating at least one of one or more conditions or status information; and transmit a communication, for the UE, associated with a measurement gap configuration, the communication being associated with the assistance information. Additionally or alternatively, the communication manager 150 may perform one or more other operations described herein.

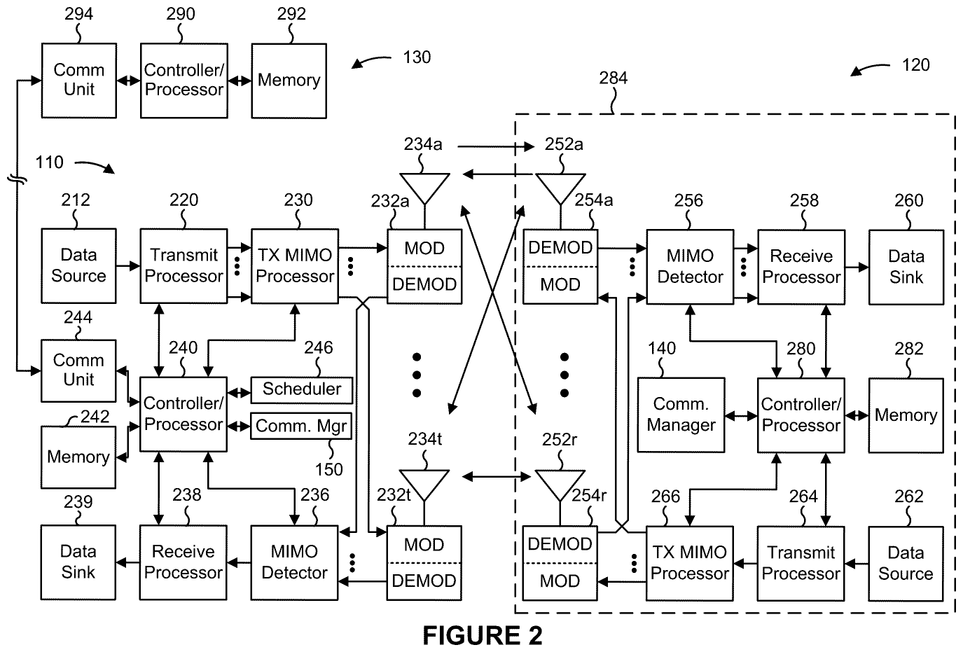

FIG. 2 is a diagram illustrating an example network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 (for example, one or more memories) to perform aspects of any of the methods described herein.

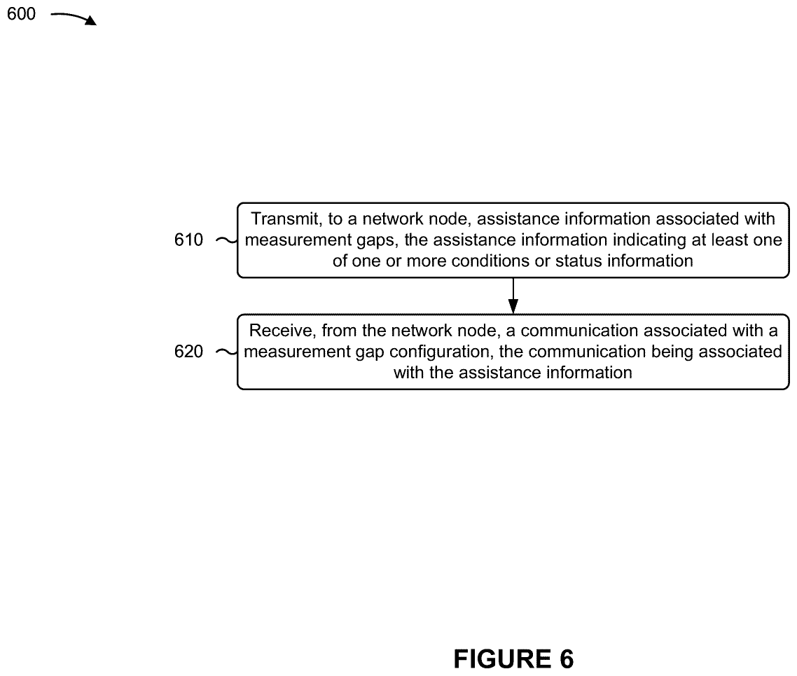

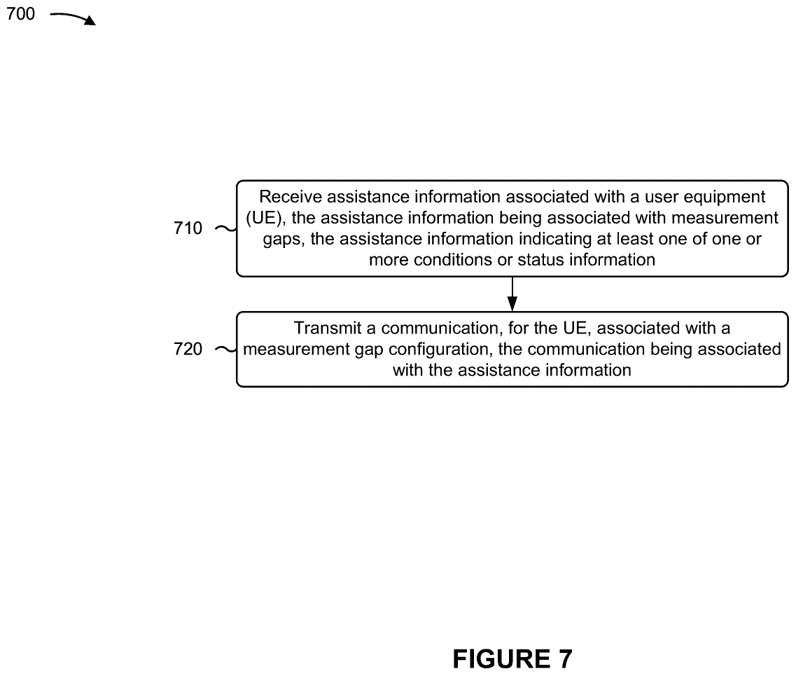

The controller/processor 240 of the network node 110, the controller/processor 280 of the UE 120, or any other component(s) of FIG. 2 may perform one or more techniques associated with assistance information for measurement gaps, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, process 700 of FIG. 7, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, or other processes as described herein. In some examples, executing instructions may include running the instructions, converting the instructions, compiling the instructions, or interpreting the instructions, among other examples. In some implementations, one or more of the multiple memories may be configured to store processor-executable code that, when executed, may configure the one or more processors to perform various functions described herein (as part of a processing system). In some other implementations, the processing system may be pre-configured to perform various functions described herein. As used herein, a function being “pre-configured” refers to configuration information, instructions, or code (for example, that, when executed by a device or processing system, is configured to cause the function to be performed) being stored in one or more memories without having received the configuration information, instructions, or code from another device (for example, stored in the one or more memories prior to the device or processing system being powered on), such as via an original equipment manufacturer (OEM) configuration.

In some aspects, an individual processor may perform all of the functions described as being performed by one or more processors. In some aspects, one or more processors may collectively perform (or be configured or operable to perform) a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, the UE 120 includes means for transmitting, to a network node, assistance information associated with measurement gaps, the assistance information indicating at least one of one or more conditions or status information; and/or means for receiving, from the network node, a communication associated with a measurement gap configuration, the communication being associated with the assistance information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving assistance information associated with a UE, the assistance information being associated with measurement gaps, and the assistance information indicating at least one of one or more conditions or status information; and/or means for transmitting a communication, for the UE, associated with a measurement gap configuration, the communication being associated with the assistance information. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

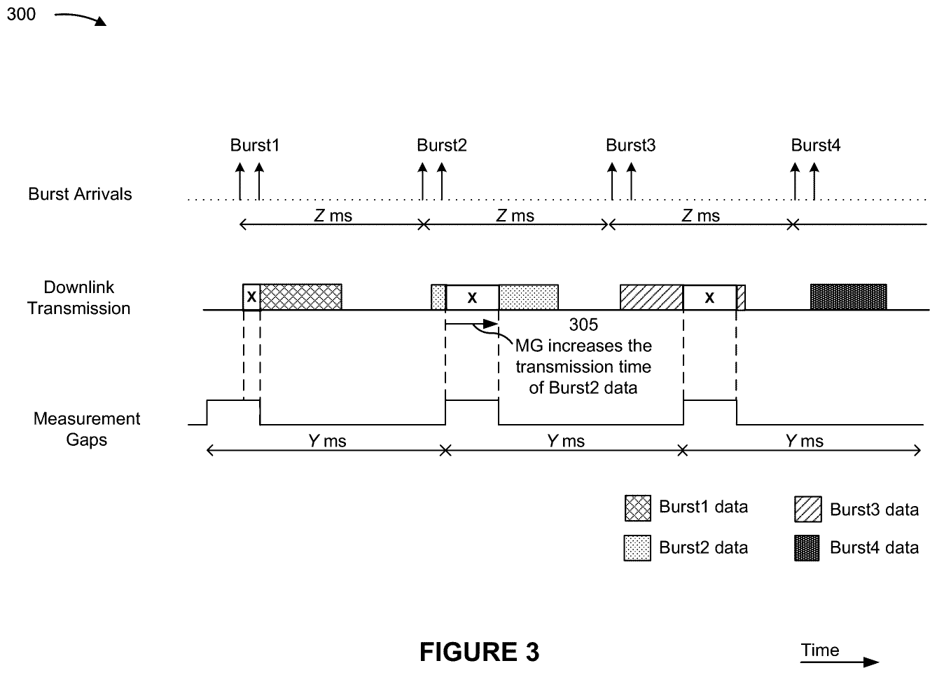

FIG. 3 is a diagram illustrating an example of a measurement gaps 300 for radio resource management (RRM) measurements.

When a UE moves within a current serving cell for the UE and triggers a mobility event (for example, an A2 mobility event, an A3 mobility event, or another mobility event defined or otherwise fixed by a wireless communication standard, such as the 3GPP), a network node may configure the UE to perform measurements (for example, RRM measurements, RSRP measurements, and/or RSRQ measurements) on candidate neighbor cells. In some examples, the UE may be configured to perform measurements on candidate neighbor cells operating on different frequencies from the current serving cell for the UE. Measurements on neighbor cells with different frequencies from the current serving cell may be referred to as “inter-frequency neighbor cell measurements.” The UE may be configured with measurement gaps to perform the inter-frequency neighbor cell measurements. Additionally or alternatively, the UE may be configured to perform measurements on candidate neighbor cells operating on the same frequencies (for example, a same frequency band) as the current serving cell for the UE. Measurements on neighbor cells with the same frequencies as the current serving cell may be referred to as “intra-frequency neighbor cell measurements.” The UE may be configured with measurement gaps to perform the intra-frequency neighbor cell measurements.

A measurement gap is a scheduled time gap in which the UE may perform neighbor cell measurements (for example, inter-frequency neighbor cell measurements and/or intra-frequency neighbor cell measurements). During a measurement gap, the UE may tune away from the frequency of the current serving cell, and the UE may tune to a target frequency of a candidate neighbor cell and perform the neighbor cell measurements on the target frequency of the target neighbor cell. The UE may not be permitted to transmit or receive data from the current serving cell during a measurement gap. For example, a UE that is configured with gap-assisted inter-frequency measurements are not schedulable during the measurement gaps. For example, during inter-frequency and intra frequency measurement gaps, the UE may be not be schedulable. The measurement gaps may have a higher priority than data traffic (for example, PDSCH traffic or physical uplink shared channel (PUSCH) traffic). For example, during a measurement gap, the MAC entity of the UE may (for example, on the serving cell(s) in the corresponding frequency range of the measurement gap configured by measGapConfig) not perform a transmission of hybrid automatic repeat request (HARQ) feedback, not perform a transmission of a scheduling request, not perform a transmission of channel state information (CSI), not report a sounding reference signal (SRS), not perform a transmission on an uplink shared channel (UL-SCH) (for example, except for some random access messages or initial attach procedure messages), not monitor a downlink control channel (for example, the physical downlink control channel (PDCCH)), and/or not receive on a downlink shared channel (DL-SCH).

In some examples, a measurement configuration that configures the UE to perform the neighbor cell measurements may include a measurement gap configuration (for example, a measGapConfig). The measurement gap configuration may indicate a length of the measurement gap (for example, 1.5 milliseconds (ms), 3 ms, 3.5 ms, 4 ms, 5.5 ms, or 6 ms) and a periodicity (for example, 20 ms, 40 ms, 80 ms, or 160 ms) of the measurement gap. The periodicity is shown as Y ms in FIG. 3. For example, the periodicity of the measurement gap may indicate a periodicity at which the measurement gap is repeated. Each repetition of a measurement gap may be referred to as a “measurement gap occasion.” The measurement gap configuration may also indicate a gap offset that indicates an offset to the first scheduled measurement gap occasion for the configured measurement gap.

In some examples, measurement gaps may delay data transfer between a UE and a network node (for example, downlink data from the network node to the UE and/or uplink data from the UE to the network node), which may be undesirable for delay critical traffic, such as XR traffic or URLLC traffic, among other examples. The delay due to measurement gaps may be particularly severe for XR traffic, because measurement gaps may have an increased likelihood of overlapping with XR traffic (as compared to other types of traffic). XR is an umbrella term encapsulating AR, VR, mixed reality (MR), or any combination thereof.

In some examples, a traffic pattern for multimedia traffic (for example, XR traffic) may include data bursts with a non-integer periodicity. For example, as shown in FIG. 3, burst arrivals (for example, downlink bursts or uplink bursts) for multimedia traffic (for example, uplink traffic to be transmitted by a UE or downlink traffic to be received by the UE) may occur with a periodicity of X ms. For example, the periodicity of X ms may be based at least in part on a frame rate (for example, a multimedia cadence) of the multimedia traffic. For example, for a frame rate of 30 Hz, X may be 33.33 or for a frame rate of 60 Hz, X may be 16.67. As used herein, “burst arrival” or “traffic arrival” refers to the arrival of data to be transmitted in a buffer of a wireless communication device (for example, a UE or a base station). A measurement gap for a UE may be configured with an integer periodicity (for example, 20 ms, 40 ms, 80 ms, or 160 ms). In some examples, the mismatch between the integer periodicity of the measurement gap and the non-integer periodicity of the multimedia traffic may result in multimedia burst traffic that overlaps with the measurement gap in one or more measurement gap occasions.

As described elsewhere herein, the UE (for example, a MAC entity of the UE) may not receive on the DL-SCH (for example, the PDCCH) during a measurement gap (for example, during a measurement gap occasion). As a result, the measurement gaps may introduce scheduling restrictions for multimedia traffic because the measurement gaps may interrupt the transmission or reception of the multimedia traffic (for example, of XR traffic). For example, as shown in FIG. 3, a transmission time (for example, an amount of time associated with a transmission of one or more packets) may be increased for some multimedia traffic bursts due to an overlap with a measurement gap occasion. For example, FIG. 3 shows burst arrivals for a first data burst (Burst1), a second data burst (Burst2), a third data burst (Burst3), and a fourth data burst (Burst4). For example, a measurement gap (MG) 305 may increase the transmission time of the Burst2 data because the UE may not receive the Burst2 traffic during the measurement gap 305. As a result, latency associated with the multimedia traffic may be increased (for example, because of the increased transmission time), negatively impacting the multimedia traffic.

In some other examples, the UE may be configured with a discontinuous reception (DRX) cycle. The DRX cycle for the UE may be configured based at least in part on the traffic pattern of the multimedia traffic. The UE may not transmit or receive the burst traffic during a measurement gap, and when the DRX inactivity timer expires during a measurement gap, the delivery of remaining data from a burst (for example, from the UE to a network node, or from the network node to the UE) is deferred to a next DRX cycle. The data in Burst1 is delivered (for example, from the UE to the network node, or from the network node to the UE) in a first DRX on duration. During the second DRX on duration, the data in Burst2 overlaps with a measurement gap (for example, in the second measurement gap occasion), and the UE cannot transmit or receive all of the data in Burst2. The DRX inactivity timer may expire during the measurement gap, and delivery of the remaining data packets from Burst2 (that were not delivered during the second DRX on duration) are delayed until the next DRX on duration (for example, the third DRX on duration). As a result, the delivery of the data from Burst2, Burst3, and Burst4 is delayed.

Such delays or increased latency may not satisfy latency requirements for delay critical traffic, such as XR traffic or multimedia traffic. For example, XR applications (for example, AR, VR, and/or MR applications) may experience significant lag due to such delays in XR traffic. Mobility measurements or RRM measurements (for example, neighbor cell measurements) may be important for the overall performance of a UE, and ignoring mobility measurements may adversely affect the performance of the UE. However, as described elsewhere herein, measurement gaps may delay data transfer, which may be undesirable for delay sensitive traffic (for example, multimedia traffic, XR traffic, and/or URLLC traffic, among other examples). For example, such delays may cause the delivery of delay critical traffic to not satisfy latency requirements and/or QoS requirements associated with the delay sensitive traffic.

In some examples, the network node may transmit, and the UE may receive, an indication to activate or deactivate a measurement gap (for example, one or more measurement gap occasions). For example, the network node may dynamically activate and/or deactivate one or more measurement gap occasions to avoid the scheduling restrictions described elsewhere herein. In some examples, the network node may transmit, and the UE may receive, a MAC-CE communication or a DCI communication that activates or deactivates one or more measurement gap occasions. For example, for a UE configured with inter-frequency measurement gaps, the network node can signal the UE to skip one or more measurement gap (for example, to avoid scheduling restrictions).

As an example, an indication to deactivate or skip a measurement gap may cause multimedia traffic or XR traffic to have a higher priority than the measurement gap. As a result, the UE may transmit or receive the multimedia traffic or XR traffic during the measurement gap (for example, rather than refraining from transmit or receive the multimedia traffic or XR traffic during the measurement gap). This may enable the UE to transmit or receive the multimedia traffic or XR traffic during without the interruption, increased latency, and/or delays caused by the measurement gap(s). An indication to activate or resume the use of a measurement gap may cause a priority of the measurement gap(s) to be restored (for example, such that the measurement gap(s) have a higher priority than the shared channel communications, such as XR communications). For example, the network node may transmit, and the UE may receive, an indication to restore the high priority for one or more measurement gap occasions (for example, a next measurement gap occasion) to cause the UE to perform one or more measurements during the one or more measurement gap occasions (for example, rather than transmitting or receiving traffic). In some examples, the network node may transmit, and the UE may receive, a DRX command indicating that the UE is to enter an inactive state before a next measurement gap occasion (for example, to enable the UE to conduct a measurement gap procedure during the next measurement gap occasion).

Therefore, the network node may dynamically activate or deactivate one or more measurement gap occasions. This may enable the network node and the UE to communicate delay sensitive traffic (such as multimedia traffic or XR traffic) when the UE is configured with a measurement gap configuration with a reduced likelihood of interruption or delay to the delay sensitive traffic that may otherwise be caused by one or more measurement gaps. Additionally, the network node may dynamically cause the UE to perform measurements during one or more measurement gap occasions, such as when a measurement gap procedure may be beneficial (for example, where the UE is experiencing poor RF conditions or has a risk of a radio link failure).

However, the network node may have incomplete information for whether measurement gaps should be activated or deactivated. For example, the UE may have uplink data to transmit (for example, with different priority values), may be moving (for example, at a given speed), and/or may be experiencing different delays on certain logical channels, among other examples. This information may impact the delay experienced by the UE, may impact an arrival time of data at the UE, may indicate an impact of activating or deactivating one or more measurement gap occasions, and/or may otherwise influence whether measurement gaps should be activated or deactivated. Because the network node may not have access to such information for whether to activate or deactivate a given measurement gap occasion, the activation or deactivation of the given measurement gap occasion may be suboptimal. For example, the network node may activate a measurement gap occasion, resulting in increased latency for uplink data to be transmitted by the UE. As another example, the network node may deactivate a measurement gap occasion when the UE is in a high mobility scenario (for example, is moving at a high speed), increasing the likelihood of a radio link failure caused by the UE moving outside of a coverage area of the network node without having performed sufficient inter-frequency or intra-frequency measurements (for example, to indicate a neighbor cell for handover).

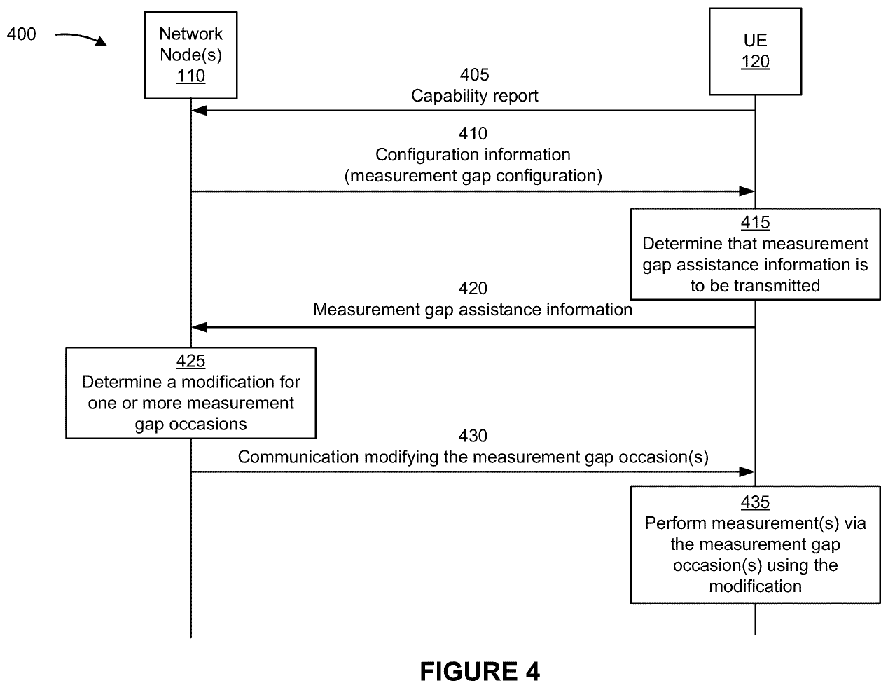

FIG. 4 is a diagram of an example of operations 400 associated with assistance information for measurement gaps. As shown in FIG. 4, one or more network nodes 110 (for example, a base station, a CU, a DU, and/or an RU) may communicate with a UE 120. In some aspects, a network node 110 and the UE 120 may be part of a wireless network (for example, the wireless network 100). The UE 120 and the network node 110 may have established a wireless connection prior to operations shown in FIG. 4.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (for example, triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

In some aspects, in a first operation 405, the UE 120 may transmit, and the network node 110 may receive, a capability report. The UE 120 may transmit the capability report via an uplink communication, a UE assistance information (UAI) communication, an uplink control information (UCI) communication, an uplink MAC-CE communication, a radio resource control (RRC) communication, a physical uplink control channel (PUCCH), and/or a PUSCH, among other examples. The capability report may indicate one or more parameters associated with respective capabilities of the UE 120. The one or more parameters may be indicated via respective information elements (IEs) included in the capability report.

The capability report may indicate whether the UE supports a feature and/or one or more parameters related to the feature. For example, the capability report may indicate a capability and/or parameter for transmitting measurement gap assistance information, as described in more detail elsewhere herein. As another example, the capability report may indicate a capability and/or parameter for indicating one or more conditions associated with a measurement gap configuration. As another example, the capability report may indicate a capability and/or parameter for delays starting times (for example, by an amount of time or a factor, referred to as “K” elsewhere herein) of one or more measurement gap occasions associated with the measurement gap configuration One or more operations described herein may be based on capability information of the capabilities report. For example, the UE may perform a communication in accordance with the capability information, or may receive configuration information that is in accordance with the capability information.

In a second operation 410, the network node 110 may transmit, and the UE 120 may receive, configuration information. In some aspects, the UE 120 may receive the configuration information via one or more of system information (for example, a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC-CEs and/or one or more DCI messages, among other examples.

The configuration information may include a measurement gap configuration. For example, the configuration information may include a measurement configuration (for example, a MeasConfig IE within an RRC configuration). The measurement configuration may include the measurement gap configuration (for example, a MeasGapConfig IE within the MeasConfig IE). The measurement gap configuration may indicate a periodicity of measurement gap occasions (for example, a measurement gap repetition period (MGRP)) indicating the periodicity (in ms) at which a measurement gap occasion repeats (for example, such as every 20 ms, 40, ms, 80, ms, or 160 ms). The measurement gap configuration may indicate a gap offset (for example, a gapOffset). The gap offset may indicate a subframe in which the measurement gap starts. For example, the gap offset may indicate a starting subframe within a repetition period for the measurement gap occasions. The measurement gap configuration may indicate a measurement gap length (for example, an mgl). The measurement gap length may indicate a length of each measurement gap occasion in ms, such as 1.5 ms, 3 ms, 3.5 ms, 4 ms, 5.5 ms, or 6 ms, among other examples.

In some aspects, the configuration information may indicate that the UE 120 is to transmit measurement gap assistance information (for example, assistance information associated with measurement gaps). For example, the configuration information may indicate that the UE 120 is to transmit an indication of one or more conditions associated with the measurement gap configuration (for example, one or more conditions associated with dynamically activating or deactivating one or more measurement gap occasions). For example, the one or more conditions may include a supported time gap (for example, S ms) between measurement gap occasions indicated by a measurement gap configuration. Additionally or alternatively, the one or more conditions may include a supported time gap (for example, X ms) between a scheduling communication and a measurement gap occasion indicated by the measurement gap configuration. For example, the one or more conditions may indicate that the UE 120 can support (for example, can take) a measurement gap occasion with one or more conditions, such as not more often than every S ms, after UE 120 is not scheduled for X ms. In some aspects, the one or more conditions may be based on, or indicate, whether delay experienced by the UE 120 is tolerant. For example, the one or conditions may indicate whether uplink delay experienced by the UE 120 satisfies a delay threshold.

Additionally or alternatively, the configuration information may indicate that the one or more measurement gap occasions are aperiodic. For example, the configuration information may indicate that the UE 120 may be configured with, or indicated with, one or more aperiodic measurement gap occasions for a measurement gap configuration. For example, the one or more aperiodic measurement gap occasions may be associated with (for example, based on) a traffic pattern which may be indicated by the measurement gap assistance information. For example, the aperiodic measurement gaps may be configured to not overlap, in the time domain, with bursty traffic, such as multimedia traffic or XR traffic. The network node 110 may determine or identify the traffic pattern (for example, traffic profile) for downlink data and/or uplink data. For example, the configuration information may indicate that the UE 120 is to transmit a time sensitive communication assistance information (TSCAI) indication that includes an indication of the traffic pattern for uplink data. In some aspects, the network node 110 may receive an indication of the downlink traffic pattern from a core network device (for example, a core network device may indicate the traffic pattern to the network node 110). The UE 120 may be configured with aperiodic measurement gaps around the XR traffic by masking (for example, deactivating) the periodic measurement gaps with an indication that activates/deactivates certain measurement gap occasions.

Additionally or alternatively, the configuration information may indicate a delay factor (for example, K or K_{GAP}) associated with one or more measurement gap occasions. The delay factor may be an offset or a scaling factor for measurements conducted within measurement gaps. The delay factor may cause the UE 120 to delay a measurement period and/or delay measurements by K. For example, K may be correlated to an amount of delay caused by (for example, induced by) data transmission (for example, multimedia data transmission or XR data transmission) to measurements to be performed in one or more measurement gap occasions. In some aspects, the delay factor may be defined, or otherwise fixed, by a wireless communication standard, such as the 3GPP. For example, the delay factor may be defined, or otherwise fixed, by 3GPP Technical Specification 38.133, such as in a table similar to the Table 9.3.5-1 in 3GPP Technical Specification 38.133 Version 18.3.0. The delay factor may be associated with multimedia traffic, XR traffic, or bursty traffic. For example, the delay factor may be specific to XR traffic (for example, may be XR specific).

The delay factor may offset a starting time of one or more measurement gap occasions (for example, may delay a starting time of the one or more measurement gap occasions). Additionally or alternatively, the delay factor may scale a measurement period associated with one or more measurement gap occasions. For example, when the network node 110 dynamically deactivates a measurement gap occasion, the deactivation may cause XR traffic (or shared channel traffic) to have a higher priority than performing a measurement via the measurement gap occasion. Therefore, the UE 120 may receive or transmit XR traffic (or shared channel traffic) during the measurement gap occasion (for example, rather than performing one or more measurements). The delay factor may delay (for example, offset) the starting time of the measurement gap occasion and/or scale the measurement period of the measurement gap occasion (for example, to cause the measurement gap occasion to be longer in the time domain) to account for the missed measurement opportunities caused by the XR traffic (or shared channel traffic).

The UE 120 may configure itself based at least in part on the configuration information. In some aspects, the UE 120 may be configured to perform one or more operations described herein based at least in part on the configuration information.

In some aspects, the configuration information described in connection with the second operation 410 and/or the capability report described in connection with the first operation 405 may include information transmitted via multiple communications. Additionally or alternatively, the network node 110 may transmit the configuration information, or a communication including at least a portion of the configuration information, before and/or after the UE 120 transmits the capability report. For example, the network node 110 may transmit a first portion of the configuration information before the capability report, the UE 120 may transmit at least a portion of the capability report, and the network node 110 may transmit a second portion of the configuration information after receiving the capability report.

In a third operation 415, the UE 120 may determine or identify that measurement gap assistance information is to be transmitted. The UE 120 may determine or identify that the measurement gap assistance information is to be transmitted (for example, reported) based on being configured with a measurement gap configuration. Additionally or alternatively, the UE 120 may determine that the measurement gap assistance information is to be transmitted (for example, reported) based on determining that the UE 120 is transmitting or receiving XR data, multimedia data, or similar types of data. Additionally or alternatively, the UE 120 may determine that the measurement gap assistance information is to be transmitted (for example, reported) based on receiving, from the network node 110, an indication to activate or deactivate one or more measurement gap occasions (for example, based on being configured to receive dynamic activations or deactivations of measurement gap occasions).

For example, the UE 120 may identify (for example, detect) an event associated with the assistance information, where the transmission of the measurement gap assistance information is associated with (for example, based on or in response to) identifying the event. For example, the event may include identifying that a measurement value of a serving cell does not satisfy a threshold (for example, detecting an A2 measurement event). Additionally or alternatively, identifying the event may include transmitting a measurement report indicating one or more measurement values (for example, where the event is associated with the transmission of the measurement report). For example, the event may be the transmission of the measurement report. Additionally or alternatively, identifying the event may include identifying a measurement gap occasion associated with the measurement gap configuration (for example, where the event is associated with causing the transmission of the assistance information to occur before the measurement gap occasion). Additionally or alternatively, identifying the event may include receiving a MAC communication (for example, one or more MAC-CE) indicating that the UE 120 is to transmit the assistance information.

For example, the UE 120 may determine that the measurement gap assistance information is to be transmitted (for example, reported) based on being configured with inter-frequency measurement gaps and/or intra-frequency measurement gaps (for example, via a MeasGapConfig or another configuration). Additionally or alternatively, the UE 120 may determine that the measurement gap assistance information is to be transmitted (for example, reported) based on being configured with network controlled small gaps (NCSG) measurement gaps. For example, the UE 120 may reconfigure a receiver bandwidth, a carrier frequency, or turn on/off one or more RF chains when performing measurements on a primary cell, an activated secondary cell, and/or an unused RF chain. However, the measurements may be interrupted on the primary cell or the activated secondary cell (or both). In this regard, the UE 120 may be configured with a NCSG, which may include a network-configured measurement gap, for the UE 120 to perform measurements on the primary cell or the activated secondary cell and avoid interruptions. Additionally or alternatively, the UE 120 may determine that the measurement gap assistance information is to be transmitted (for example, reported) based on detecting a measurement event when configured with inter-frequency measurement gaps and/or intra-frequency measurement gaps. For example, the measurement event may include an A2 event (for example, where a measurement of the signal received from a serving cell does not satisfy a threshold), or another measurement event (for example, defined, or otherwise fixed, by a wireless communication standard, such as the 3GPP).

In some aspects, the UE 120 may determine that the measurement gap assistance information is to be transmitted (for example, reported) based on a timing of the configured measurement gaps. For example, the UE 120 may be configured to transmit the measurement gap assistance information prior to a measurement gap occasion (for example, prior to each measurement gap occasion). For example, the transmission of the measurement gap assistance information may be aligned with a timing of a measurement gap occasion. In such examples, “aligned” may refer to the transmission of the measurement gap assistance information being an amount of time prior to a start of a measurement gap occasion. For example, the UE 120 may be configured to transmit the measurement gap assistance information T ms prior to the start of the measurement gap occasion (for example, if the measurement gap occasion is configured to start at a time T₁, the transmission of the measurement gap assistance information may be T₁-T).

As another example, the UE 120 may determine that the measurement gap assistance information is to be transmitted (for example, reported) based on a timing of a measurement report (for example, that includes one or more measurements performed during a measurement gap occasion). The transmission of the measurement gap assistance information may be before or after the transmission of the measurement report. For example, the transmission of the measurement gap assistance information may be aligned with a timing of a transmission of a measurement report. In such examples, “aligned” may refer to the transmission of the measurement gap assistance information being an amount of time prior to, or after, the transmission of the measurement report. For example, the UE 120 may be configured to transmit the measurement gap assistance information M ms before or after the measurement report (for example, if measurement report is transmitted at a time T₂, the transmission of the measurement gap assistance information may be T₂±M).

In some aspects, the network node 110 may transmit, and the UE 120 may receive, an indication that measurement gap assistance information is to be transmitted. For example, the UE 120 may be configured to transmit the measurement gap assistance information (for example, via an RRC configuration). The UE 120 may receive an activation communication activating the transmission of the measurement gap assistance information (for example, via one or more MAC-CEs and/or DCI signaling). For example, the network node 110 may activate or deactivate the transmission of measurement gap assistance information by the UE 120 (for example, to facilitate a which configured measurement gap occasions should be activated or deactivated for the UE 120). In some aspects, the network node 110 may activate the transmission of the measurement gap assistance information (for example, to be transmitted when a measurement event is detected by the UE 120 or without a measurement event being detected by the UE 120).

In a fourth operation 420, the UE 120 may transmit, and the network node 110 may receive, the measurement gap assistance information. For example, the UE 120 may transmit, and the network node 110 may receive, assistance information associated with measurement gaps. The UE 120 may transmit the measurement gap assistance information via Layer 1 (L1) signaling, Layer 2 (L2) signaling, and/or Layer 3 (L3) signaling. For example, the UE 120 may transmit the measurement gap assistance information via RRC signaling, MAC signaling (for example, one or more uplink MAC-CEs), and/or UCI signaling, among other examples. The UE 120 may transmit the measurement gap assistance information via the PUSCH or the PUCCH. In some aspects, the measurement gap assistance information may be included in a UAI communication.

As described elsewhere herein, a timing of the transmission of the measurement gap assistance information may be based on a timing of a measurement gap occasion. For example, the UE 120 may transmit the measurement gap assistance information a given amount of time prior to a start of a configured measurement gap occasion (for example, to facilitate whether the measurement gap occasion should be activated or deactivated). As another example, the timing of the transmission of the measurement gap assistance information may be based on a timing of a measurement report. For example, the UE 120 may transmit the measurement gap assistance information a given amount of time prior to, or after, a transmission of a measurement report (for example, an inter-frequency measurement report or an intra-frequency measurement report).

The UE 120 may determine, identify, or obtain the measurement gap assistance information. In some aspects, the UE 120 may determine the measurement gap assistance information based on an experienced delay (for example, an experience uplink delay or a downlink delay). The experienced delay may be a delay of uplink data (for example, uplink XR data) caused by one or more measurement gap occasions. For example, the UE 120 may determine one or more conditions associated with the configured measurement gaps based on the experienced delay. As an example, the UE 120 may determine the one or more conditions to reduce a likelihood that (or reduce how often) measurement gap occasions overlap, in the time domain, with transmission of uplink data or the reception of downlink data (for example, multimedia data or XR data). For example, the one or more conditions may include a supported time gap (for example, S ms) between measurement gap occasions indicated by a measurement gap configuration. Additionally or alternatively, the one or more conditions may include a supported time gap (for example, X ms) between a scheduling communication and a measurement gap occasion indicated by the measurement gap configuration. For example, the one or more conditions may indicate that the UE 120 can support (for example, can take) a measurement gap occasion with one or more conditions, such as not more often than every S ms, after UE 120 is not scheduled for X ms. In some aspects, the one or more conditions may be based on, or indicate, whether delay experienced by the UE 120 is tolerant. For example, the one or conditions may indicate whether uplink delay experienced by the UE 120 satisfies a delay threshold. As another example, the UE 120 may include the one or more conditions in the measurement gap assistance information based on the uplink delay experienced by the UE 120 not satisfying the delay threshold (for example, based on the UE 120 experiencing high delay in the uplink).

The measurement gap assistance information may include the one or more conditions and/or status information (for example, of the UE 120). The status information may indicate a data or traffic status, a mobility status, and/or another status of the UE 120. In some aspects, the measurement gap assistance information (for example, the status information) may indicate a traffic pattern. The traffic pattern may be an uplink traffic pattern, such as for uplink multimedia data, uplink XR data, or similar uplink data. For example, the UE 120 may determine that the uplink data (for example, multimedia data or XR data) is arriving at the UE 120 to be transmitted according to a certain burst periodicity, as described in more detail elsewhere herein. The measurement gap assistance information may indicate the periodicity associated with the uplink data (for example, multimedia data or XR data) at the UE 120.

In some aspects, the measurement gap assistance information may be included in, or may include, a buffer status report (BSR). For example, the status information may include a BSR. For example, the BSR may can help the network node 110 to assess the impact of a measurement gap on data transmission by the UE 120 and adjust the scheduling of one or more measurement gap occasions accordingly. For example, a BSR (for example, a transmission of a BSR) may be triggered (for example, for an activated cell group) if the UE 120 determines to transmit the measurement gap assistance information, as described in more detail elsewhere herein. For example, a BSR (for example, a transmission of a BSR) may be triggered (for example, for an activated cell group) if the UE 120 detects a measurement event (for example, an A2 event or another measurement event) and the UE 120 is configured with a measurement gap configuration (for example, an inter-frequency measurement gaps and/or intra-frequency measurement gaps). The BSR (for example, a transmission of a BSR) may be aligned with a measurement gap occasion and/or a measurement report, as described in more detail elsewhere herein.

Additionally or alternatively, the measurement gap assistance information may be included in, or may include, a delay status report (DSR). For example, the status information may include a DSR. For example, delay status reporting and/or delay statistics reporting (sometimes referred to as statistical delay reporting) may be useful to schedule delay-sensitive traffic, such as XR traffic, more efficiently than using a PDU set delay budget (PSDB) or a packet delay budget (PDB). For example, a delay budget (for example, a PSDB or PDB) generally starts when a protocol data unit (PDU) or a PDU set arrives in an uplink buffer associated with the UE 120, rather than when the network node 110 is informed about the existence of a PDU from a BSR that the UE 120 transmits to indicate how much uplink data is in the uplink buffer. Accordingly, the PSDB/PDB may be insufficient to schedule XR or other delay-sensitive traffic efficiently, because the network node 110 is unable to know the remaining delay budget (RDB) for buffered uplink data (for example, because the BSR does not indicate how much data is buffered for how long). As a result, the network node 110 is unable to determine when the delay budget associated with a buffered PDU will deplete, whereby a PSDB/PDB alone cannot adequately enable enhanced scheduling for delay-sensitive traffic. Accordingly, because the RDB (rather than the PSDB/PDB) indicates how soon a network node needs to provide uplink grants, the network node 110 may configure the UE 120 to dynamically report an RDB associated with a PDU stored in an L2 buffer associated with the UE 120 (for example, in a DSR), where the RDB may be defined as a difference between a PDB or PSDB of a QoS flow associated with the PDU and the time that has elapsed since the PDU was received at a service data adaption protocol (SDAP) layer. In this way, the network node 110 may know the RDB for buffered uplink data and issue uplink grants before the deadline associated with the buffered uplink data.

In some aspects, as described herein, one or more triggers may be defined (for example, in a wireless communication standard) and/or configured (for example, by the network node) to define when a UE 120 is to transmit a DSR to the network node. For example, in some aspects, the network node may generally configure one or more logical channel groups (LCGs) for which the UE 120 is to provide a DSR (for example, the network configures which LCGs should report DSR), where each LCG may include one or more logical channels (LCHs). For example, the UE 120 may be configured with multiple LCHs, and may have data associated with one or more LCHs available for transmission at a time when the UE has an allocation of uplink resources. In general, transmission of a DSR may be event-triggered or timer-triggered, which may be configured per LCG. For example, in an event-triggered DSR, the network node may configure a reporting threshold related to an RDB for an associated LCG, and a DSR may be triggered (for example, the UE may transmit a DSR for the associated LCG) based on a minimum RDB among all PDUs in the associated LCG failing to satisfy (for example, is below) the reporting threshold. Additionally or alternatively, in a timer-triggered DSR, the network node may configure a periodic DSR timer for an LCG, and expiry of the DSR timer may trigger a DSR. In general, a triggered DSR (for example, an event-triggered or timer-triggered DSR) may remain pending until an associated DSR MAC-CE is included in a PUSCH transmission, and a pending DSR may trigger a scheduling request until the pending DSR has been cancelled

For example, a trigger to define when the UE 120 is to transmit a DSR to the network node 110 may include the UE 120 transmitting the measurement gap assistance information, as described in more detail elsewhere herein. For example, a DSR (for example, a transmission of a DSR) may be triggered (for example, for an activated cell group) if the UE 120 is to transmit the measurement gap assistance information, as described in more detail elsewhere herein. For example, a DSR (for example, a transmission of a DSR) may be triggered (for example, for an activated cell group) if the UE 120 detects a measurement event (for example, an A2 event or another measurement event) and the UE 120 is configured with a measurement gap configuration (for example, an inter-frequency measurement gaps and/or intra-frequency measurement gaps). The DSR (for example, a transmission of a DSR) may be aligned with a measurement gap occasion and/or a measurement report, as described in more detail elsewhere herein.

Additionally or alternatively, the measurement gap assistance information may include a data priority indicator of traffic associated with the UE 120. For example, the status information may include a data priority indicator. The data priority indicator may be a priority indicator of the data to be transmitted by the UE 120. For example, the data priority indicator may be based on QoS indicator, such as a 5G QoS identifier (5QI). For example, the data priority indicator may be a 5QI. Additionally or alternatively, the measurement gap assistance information may include an estimated time of arrival of traffic associated with the UE 120. The estimated time of arrival may be associated with traffic to be transmitted by the UE 120. Additionally or alternatively, the estimated time of arrival may be associated with traffic received by the UE 120. The estimated time of arrival may be useful for the network node 110 for whether a measurement gap occasion is to be activated or deactivated (for example, if the estimated time of arrival occurs during a measurement gap occasion, then the network node 110 may determine that the measurement gap occasion is to be deactivated).

Additionally or alternatively, the measurement gap assistance information may include an energy status report (sometimes referred to as a power status report). For example, the status information may include an energy status report. The energy status report may indicate energy consumption by the UE 120. Additionally or alternatively, the measurement gap assistance information may include an indication of a speed of the UE 120. For example, the status information may include an indication of the speed of the UE 120. For example, the UE 120 may measure (for example, using one or more sensors) the speed of the UE 120. The speed of the UE 120 may be indicative of whether measurements should be performed by the UE 120. For example, if the UE 120 is moving at relatively high speeds, then it may be beneficial for the UE 120 to perform measurements (for example, inter-frequency and/or intra-frequency measurements) because the UE 120 may move outside of a coverage area of the network node 110. If the UE 120 is moving at relatively low speeds (or is stationary), then the UE 120 may not need to perform measurements because channel conditions are unlikely to change.

Additionally or alternatively, the measurement gap assistance information may include an indication to delay one or more measurement gap occasions associated with the measurement gap configuration. For example, the UE 120 may indicate that one or more measurement gap occasions (for example, one or more upcoming measurement gap occasions) should be delayed or deactivated. Additionally or alternatively, the measurement gap assistance information may include an indication that a new measurement gap configuration is needed.

In some aspects, the UE 120 may be configured with a configured grant resource (or another uplink resource) for transmitting the measurement gap assistance information. For example, to avoid a delay from the UE associated with obtaining resources for the transmission of the measurement gap assistance information, the UE 120 may be configured with uplink shared channel resources (for example, a CG-PUSCH) for transmission of the measurement gap assistance information (for example, for the transmission of a BSR, a DSR, or other measurement gap assistance information).

In a fifth operation 425, the network node 110 may modify one or more measurement gap occasions. The network node 110 may modify using the measurement gap assistance information. For example, the network node 110 may activate or deactivate one or more measurement gap occasions using the measurement gap assistance information. In some aspects, the network node 110 may modify to the measurement gap configuration using the measurement gap assistance information. In some aspects, the network node 110 may determine the delay factor (for example, K) for one or more measurement gap occasions using the measurement gap assistance information. Using the measurement gap assistance information may improve the modification for one or more measurement gap occasions.

For example, in a sixth operation 430, the network node 110 may transmit, and the UE 120 may receive, a communication modifying the one or more measurement gap occasions. For example, the network node 110 may transmit, and the UE 120 may receive, a communication associated with a measurement gap configuration. The communication may indicate an activation or deactivation of one or more measurement gap occasions. Additionally or alternatively, the communication may indicate a modification of the measurement gap configuration (for example, a modification of one or more parameters, such as a periodicity of measurement gap occasions (an MGRP), a gap offset (a gapOffset), and/or a measurement gap length (an mgl)).

For example, the UE 120 may expect the communication in response to the transmission of the measurement gap assistance information. The network node 110 may transmit, and the UE 120 may receive, the communication via MAC signaling (for example, one or more MAC-CEs) and/or physical layer signaling (for example, DCI), among other examples. The communication may activate, deactivate, or delay one or more measurement gap occasions (for example, for a given period of time). Additionally or alternatively, the communication may include indications for respective measurement gap occasions. For example, the communication may include a bitmap that includes bits for respective measurement gap occasions (for example, for W measurement gap occasions, where the bitmap includes W bits). Each indication (for example, each bit) may indicate whether a corresponding measurement gap occasion is activated, deactivated, and/or delayed. Additionally or alternatively, the communication may include a start and length indicator value (SLIV). The SLIV may indicate a starting time and an amount of time for which the information indicated by the communication is applicable. For example, the SLIV may indicate a starting time and an amount of time for which measurement gaps are to be activated, deactivated, or delayed. Additionally or alternatively, the communication may indicate the delay factor (K) associated with the measurement gaps, as described in more detail elsewhere herein.

In some aspects, the communication may configure or indicate one or more aperiodic measurement gap occasions. For example, aperiodic measurement gaps may be used for XR periodic traffic. For example, the network node 110 may determine the traffic pattern or profile associated with the XR traffic. The network node 110 may indicate one or more aperiodic measurement gap occasions to cause the aperiodic measurement gap occasions to not overlap, in the time domain, with a transmission of the XR traffic (for example, based on the traffic pattern or profile associated with the XR traffic). For example, the communication may indicate a deactivation of one or more configured measurement gap occasions to indicate the one or more aperiodic measurement gap occasions (for example, where the one or more aperiodic measurement gap occasions are configured measurement gap occasions that are not indicated as being deactivated).

In some aspects, the communication may indicate the delay factor (K) associated with one or more measurement gap occasions. For example, inter-frequency and/or intra-frequency measurement gaps may be delayed dynamically or semi-statically (for example, to account for the delay in the measurement when there is XR traffic) by offset K that is signaling in DCI and/or one or more MAC-CEs (for example, such that K can be XR specific and depend on how much data has taken from the measurement gap occasion). The delay factor may apply to a single measurement gap occasion or multiple measurement gap occasions. In some aspects, the communication may indicate a value for the delay factor. In other aspects, the communication may indicate that the delay factor is to be applied by the UE 120 (for example, and the value of the delay factor may be defined, or otherwise fixed, by a wireless communication standard, such as the 3GPP).

For example, rather than completely deactivating a measurement gap occasion, the network node 110 may indicate that the measurement period of a measurement gap occasion is to be delayed, offset, and/or scaled by the delay factor (for example, where the delay factor is correlated with the amount of delay caused by XR data). In some aspects, the delay factor, K, may refer to an offset that is applied to the start of a measurement gap occasion. In other aspects, the delay factor, K, may refer to a scaling value to be applied to a length or measurement period of a measurement gap occasion.

The delay factor may be indicated via an RRC communication (for example, in the configuration information transmitted via the second operation 410), one or more MAC-CE communications, and/or one or more DCI communications. In some aspects, the delay factor may be indicated via a communication (for example, a MAC-CE communication or a DCI communication) that activates or deactivates a measurement gap occasion.

In a seventh operation 435, the UE 120 may perform one or more measurement via the one or more measurement gap occasions using the modification. For example, the UE 120 may perform one or more measurement via the one or more measurement gap occasions in accordance with the modification. As an example, the UE 120 may deactivate one or more measurement gap occasions (for example, by considering shared channel data, such as XR data, to have a higher priority than the one or more measurement gap occasions). As another example, the UE 120 may delay or scale a measurement period for one or more measurement gap occasion as indicated by the delay factor (K).

In some aspects, the UE 120 may transmit and/or receive data (for example, XR data) during a time that is associated with a configured measurement gap occasion (for example, a delayed or deactivated measurement gap occasion). For example, the UE 120 may receive data associated with a traffic flow. The UE 120 may perform, during a duration of the traffic flow, one or more measurements during a measurement gap in accordance with the modification of the measurement gap configuration. Additionally or alternatively, the UE 120 may transmit or receive data associated with the traffic flow during the measurement gap in accordance with the modification. The traffic flow may be an XR traffic flow. This may reduce the latency and/or improve the performance of the communication of the data.

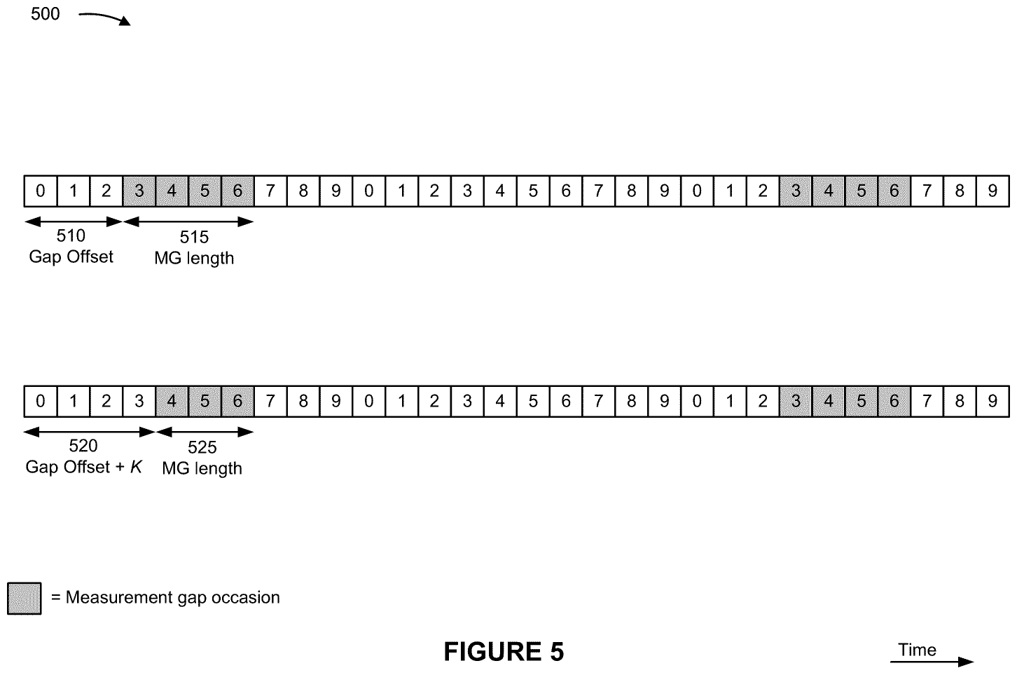

FIG. 5 is a diagram of an example 500 of a delay factor associated with measurement gaps. As shown in FIG. 5, a measurement gap occasion may be configured via a gap offset 510 and an MG length 515. For example, the gap offset 510 may indicate a starting subframe for the measurement gap occasion (shown as a subframe 3 in FIG. 5). The MG length 515 may indicate an amount of time associated with the measurement gap occasion.

In some aspects, a UE 120 may receive an indication to apply a delay factor (K) to one or more measurement gap occasions. In some aspects, as shown in FIG. 5, the delay factor may cause a start of a measurement gap occasion to be delayed. For example, a starting time 520 of a measurement gap occasion (for example, when the UE 120 is configured or indicated to apply the delay factor) may be indicated by the gap offset 510+K. In some aspects, applying the delay factor may cause the length of the measurement gap occasion to be shortened (as compared to a configured length and as shown by the MG length 525). In some other aspects, applying the delay factor may not impact the length of the measurement gap occasion and may cause the measurement gap occasion to end later than originally configured, such as in subframe 7 shown in FIG. 5.

In some aspects, applying the delay factor may cause the UE 120 to delay when measurements are performed by the UE 120 (for example, rather than modifying the configured measurement gap occasion). For example, the UE 120 may delay a measurement period (for example, a period of time during which measurements are performed by the UE 120) in accordance with the delay factor.

In some aspects, the delay factor may be a scaling factor for the MG length 515. For example, the delay factor may scale the MG length 515. For example, when the UE 120 is configured or indicated to apply the delay factor, a measurement gap occasion may have a length of mgl×K, where mgl is the MG length 515.

Applying the delay factor may enable the network node 110 to modify measurement gap occasions to not overlap, in the time domain, with periodic or bursty traffic, such as XR traffic or multimedia traffic (for example, while still providing an opportunity for the UE 120 to perform one or more measurements during the measurement gap occasion). Additionally or alternatively, the applying the delay factor may enable the network node 110 to account for an amount of time (or an opportunity) lost for measurement caused by the transmission or reception of data (for example, shared channel data, XR data, or multimedia data) during the measurement gap occasion.

FIG. 6 is a flowchart illustrating an example process 600 performed, for example, at a UE or an apparatus of a UE that supports operations associated with assistance information for measurement gaps. Example process 600 is an example where the apparatus or the UE (for example, UE 120) performs operations associated with assistance information for measurement gaps.

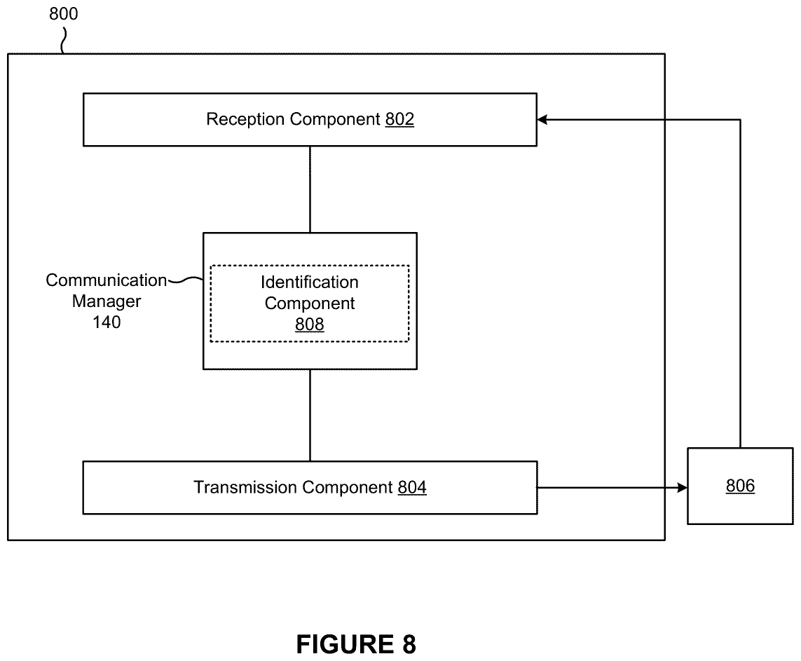

As shown in FIG. 6, in some aspects, process 600 may include transmitting, to a network node, assistance information associated with measurement gaps, the assistance information indicating at least one of one or more conditions or status information (block 610). For example, the UE (such as by using communication manager 140 or transmission component 804, depicted in FIG. 8) may transmit, to a network node, assistance information associated with measurement gaps, the assistance information indicating at least one of one or more conditions or status information, as described above.

As further shown in FIG. 6, in some aspects, process 600 may include receiving, from the network node, a communication associated with a measurement gap configuration, the communication being associated with the assistance information (block 620). For example, the UE (such as by using communication manager 140 or reception component 802, depicted in FIG. 8) may receive, from the network node, a communication associated with a measurement gap configuration, the communication being associated with the assistance information, as described above.

Process 600 may include additional aspects, such as any single aspect or any combination of aspects described below or in connection with one or more other processes described elsewhere herein.

In a first additional aspect, the one or more conditions are associated with the measurement gap configuration.

In a second additional aspect, alone or in combination with the first aspect, the one or more conditions include a supported time gap between measurement gap occasions indicated by the measurement gap configuration.

In a third additional aspect, alone or in combination with one or more of the first and second aspects, the assistance information indicates a supported time gap between a scheduling communication and a measurement gap occasion indicated by the measurement gap configuration.

In a fourth additional aspect, alone or in combination with one or more of the first through third aspects, the communication indicates one or more aperiodic measurement gap occasions for the measurement gap configuration, the one or more aperiodic measurement gap occasions being associated with a traffic pattern indicated by the assistance information.

In a fifth additional aspect, alone or in combination with one or more of the first through fourth aspects, the communication indicates a delay factor associated with one or more measurement gap occasions configured by the measurement gap configuration.

In a sixth additional aspect, alone or in combination with one or more of the first through fifth aspects, the delay factor indicates that starting times of the one or more measurement gap occasions are to be delayed by an amount of time.

In a seventh additional aspect, alone or in combination with one or more of the first through sixth aspects, the delay factor indicates that durations of the one or more measurement gap occasions are to be scaled.

In an eighth additional aspect, alone or in combination with one or more of the first through seventh aspects, process 600 includes identifying an event associated with the assistance information, the transmission of the assistance information being associated with identifying the event.

In a ninth additional aspect, alone or in combination with one or more of the first through eighth aspects, identifying the event includes receiving configuration information indicating the measurement gap configuration.

In a tenth additional aspect, alone or in combination with one or more of the first through ninth aspects, identifying the event includes identifying that a measurement value of a serving cell does not satisfy a threshold.

In an eleventh additional aspect, alone or in combination with one or more of the first through tenth aspects, process 600 includes transmitting a measurement report indicating the measurement value, the event being associated with the transmission of the measurement report.

In a twelfth additional aspect, alone or in combination with one or more of the first through eleventh aspects, identifying the event includes identifying a measurement gap occasion associated with the measurement gap configuration, the event being associated with causing the transmission of the assistance information to occur before the measurement gap occasion.

In a thirteenth additional aspect, alone or in combination with one or more of the first through twelfth aspects, identifying the event includes receiving a medium access control communication indicating that the UE is to transmit the assistance information.

In a fourteenth additional aspect, alone or in combination with one or more of the first through thirteenth aspects, the status information includes a buffer status report.

In a fifteenth additional aspect, alone or in combination with one or more of the first through fourteenth aspects, the status information includes a delay status report.

In a sixteenth additional aspect, alone or in combination with one or more of the first through fifteenth aspects, the status information includes a data priority indicator of traffic associated with the UE.

In a seventeenth additional aspect, alone or in combination with one or more of the first through sixteenth aspects, the status information includes an estimated time of arrival of traffic associated with the UE.

In an eighteenth additional aspect, alone or in combination with one or more of the first through seventeenth aspects, the status information includes an energy status report.

In a nineteenth additional aspect, alone or in combination with one or more of the first through eighteenth aspects, the status information includes an indication of a speed of the UE.

In a twentieth additional aspect, alone or in combination with one or more of the first through nineteenth aspects, the assistance information includes an indication to delay one or more measurement gap occasions associated with the measurement gap configuration.

In a twenty-first additional aspect, alone or in combination with one or more of the first through twentieth aspects, the communication indicates an activation or deactivation of one or more measurement gap occasions associated with the measurement gap configuration.

In a twenty-second additional aspect, alone or in combination with one or more of the first through twenty-first aspects, the communication indicates a delay associated with starting times of one or more measurement gap occasions associated with the measurement gap configuration.

In a twenty-third additional aspect, alone or in combination with one or more of the first through twenty-second aspects, the communication indicates a modification of the measurement gap configuration, and process 600 includes receiving data associated with a traffic flow, and performing, during a duration of the traffic flow, one or more measurements during a measurement gap in accordance with the modification of the measurement gap configuration.

In a twenty-fourth additional aspect, alone or in combination with one or more of the first through twenty-third aspects, the traffic flow is an XR traffic flow.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports operations associated with assistance information for measurement gaps. Example process 700 is an example where the apparatus or the network node (for example, network node 110) performs operations associated with assistance information for measurement gaps.

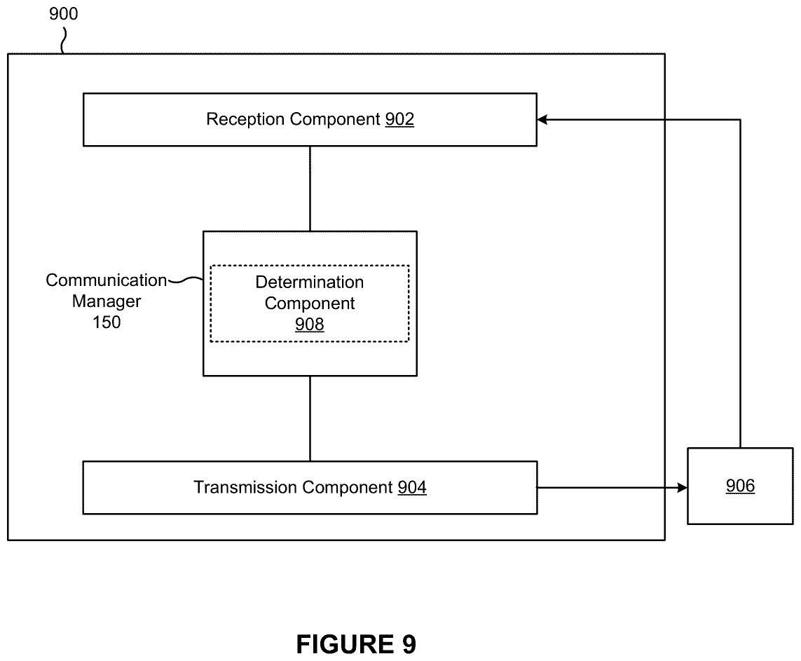

As shown in FIG. 7, in some aspects, process 700 may include receiving assistance information associated with a UE, the assistance information being associated with measurement gaps, and the assistance information indicating at least one of one or more conditions or status information (block 710). For example, the network node (such as by using communication manager 150 or reception component 902, depicted in FIG. 9) may receive assistance information associated with a UE, the assistance information being associated with measurement gaps, and the assistance information indicating at least one of one or more conditions or status information, as described above.

As further shown in FIG. 7, in some aspects, process 700 may include transmitting a communication, for the UE, associated with a measurement gap configuration, the communication being associated with the assistance information (block 720). For example, the network node (such as by using communication manager 150 or transmission component 904, depicted in FIG. 9) may transmit a communication, for the UE, associated with a measurement gap configuration, the communication being associated with the assistance information, as described above.

Process 700 may include additional aspects, such as any single aspect or any combination of aspects described below or in connection with one or more other processes described elsewhere herein.

In a first additional aspect, the one or more conditions are associated with the measurement gap configuration.

In a second additional aspect, alone or in combination with the first aspect, the one or more conditions include a supported time gap between measurement gap occasions indicated by the measurement gap configuration.

In a third additional aspect, alone or in combination with one or more of the first and second aspects, the one or more conditions include a supported time gap between a scheduling communication and a measurement gap occasion indicated by the measurement gap configuration.

In a fourth additional aspect, alone or in combination with one or more of the first through third aspects, the communication indicates one or more aperiodic measurement gap occasions for the measurement gap configuration, the one or more aperiodic measurement gap occasions being associated with a traffic pattern indicated by the assistance information.

In a fifth additional aspect, alone or in combination with one or more of the first through fourth aspects, the communication indicates a delay factor associated with one or more measurement gap occasions configured by the measurement gap configuration.

In a sixth additional aspect, alone or in combination with one or more of the first through fifth aspects, the delay factor indicates that starting times of the one or more measurement gap occasions are to be delayed by an amount of time.

In a seventh additional aspect, alone or in combination with one or more of the first through sixth aspects, the delay factor indicates that durations of the one or more measurement gap occasions are to be scaled.

In an eighth additional aspect, alone or in combination with one or more of the first through seventh aspects, the reception of the assistance information is associated with an event.

In a ninth additional aspect, alone or in combination with one or more of the first through eighth aspects, process 700 includes transmitting configuration information indicating the measurement gap configuration, the event being associated with the transmission of the configuration information.

In a tenth additional aspect, alone or in combination with one or more of the first through ninth aspects, the event is associated with a measurement value of a serving cell does not satisfy a threshold.

In an eleventh additional aspect, alone or in combination with one or more of the first through tenth aspects, process 700 includes receiving a measurement report indicating the measurement value, the event being associated with the reception of the measurement report.

In a twelfth additional aspect, alone or in combination with one or more of the first through eleventh aspects, the event is associated with a timing of a measurement gap occasion associated with the measurement gap configuration, the event being associated with causing the reception of the assistance information to occur before the measurement gap occasion.

In a thirteenth additional aspect, alone or in combination with one or more of the first through twelfth aspects, process 700 includes transmitting a medium access control communication indicating that the UE is to transmit the assistance information, the event being associated with the transmission of the medium access control communication.

In a fourteenth additional aspect, alone or in combination with one or more of the first through thirteenth aspects, the status information includes a buffer status report.

In a fifteenth additional aspect, alone or in combination with one or more of the first through fourteenth aspects, the status information includes a delay status report.

In a sixteenth additional aspect, alone or in combination with one or more of the first through fifteenth aspects, the status information includes a data priority indicator of traffic associated with the UE.

In a seventeenth additional aspect, alone or in combination with one or more of the first through sixteenth aspects, the status information includes an estimated time of arrival of traffic associated with the UE.

In an eighteenth additional aspect, alone or in combination with one or more of the first through seventeenth aspects, the status information includes an energy status report.

In a nineteenth additional aspect, alone or in combination with one or more of the first through eighteenth aspects, the status information includes an indication of a speed of the UE.

In a twentieth additional aspect, alone or in combination with one or more of the first through nineteenth aspects, the assistance information includes an indication to delay one or more measurement gap occasions associated with the measurement gap configuration.

In a twenty-first additional aspect, alone or in combination with one or more of the first through twentieth aspects, the communication indicates an activation or deactivation of one or more measurement gap occasions associated with the measurement gap configuration.

In a twenty-second additional aspect, alone or in combination with one or more of the first through twenty-first aspects, the communication indicates a delay associated with starting times of one or more measurement gap occasions associated with the measurement gap configuration.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports operations associated with assistance information for measurement gaps. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIGS. 4 and 5. Additionally or alternatively, the apparatus 800 may be configured to and/or operable to perform one or more processes described herein, such as process 600 of FIG. 6. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 804 may be co-located with the reception component 802 in one or more transceivers.

The communication manager 140 may transmit or may cause the transmission component 804 to transmit, to a network node, assistance information associated with measurement gaps, the assistance information indicating at least one of one or more conditions or status information. The communication manager 140 may receive or may cause the reception component 802 to receive, from the network node, a communication associated with a measurement gap configuration, the communication being associated with the assistance information. In some aspects, the communication manager 140 may perform one or more operations described elsewhere herein as being performed by one or more components of the communication manager 140.

The communication manager 140 may include one or more controllers/processors, one or more memories, of the UE described above in connection with FIG. 2. In some aspects, the communication manager 140 includes a set of components, such as an identification component 808. Alternatively, the set of components may be separate and distinct from the communication manager 140. In some aspects, one or more components of the set of components may include or may be implemented within one or more controllers/processors, one or more memories, of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 804 may transmit, to a network node, assistance information associated with measurement gaps, the assistance information indicating at least one of one or more conditions or status information. The reception component 802 may receive, from the network node, a communication associated with a measurement gap configuration, the communication being associated with the assistance information.

The identification component 808 may identify an event associated with the assistance information, the transmission of the assistance information being associated with identifying the event.

The transmission component 804 may transmit a measurement report indicating the measurement value, the event being associated with the transmission of the measurement report.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports operations associated with assistance information for measurement gaps. The apparatus 900 may be a network node, or a network node may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 4 and 5. Additionally or alternatively, the apparatus 900 may be configured to and/or operable to perform one or more processes described herein, such as process 700 of FIG. 7. In some aspects, the apparatus 900 may include one or more components of the network node described above in connection with FIG. 2.

The reception component 902 may receive communications, such as reference signals, control information, and/or data communications, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the network node described above in connection with FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 904 may be co-located with the reception component 902 in one or more transceivers.

The communication manager 150 may receive or may cause the reception component 902 to receive assistance information associated with a UE, the assistance information being associated with measurement gaps, and the assistance information indicating at least one of one or more conditions or status information. The communication manager 150 may transmit or may cause the transmission component 904 to transmit a communication, for the UE, associated with a measurement gap configuration, the communication being associated with the assistance information. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a determination component 908. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive assistance information associated with a UE, the assistance information being associated with measurement gaps, and the assistance information indicating at least one of one or more conditions or status information. The transmission component 904 may transmit a communication, for the UE, associated with a measurement gap configuration, the communication being associated with the assistance information.

The determination component 908 may determine a modification for the measurement gap configuration using the assistance information. The modification may include an activation or deactivation of one or more measurement gap occasions. The modification may include an application of a delay factor (K).

The transmission component 904 may transmit configuration information indicating the measurement gap configuration, the event being associated with the transmission of the configuration information.

The reception component 902 may receive a measurement report indicating the measurement value, the event being associated with the reception of the measurement report.

The transmission component 904 may transmit a medium access control communication indicating that the UE is to transmit the assistance information, the event being associated with the transmission of the medium access control communication.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed at a user equipment (UE), comprising: transmitting, to a network node, assistance information associated with measurement gaps, the assistance information indicating at least one of one or more conditions or status information; and receiving, from the network node, a communication associated with a measurement gap configuration, the communication being associated with the assistance information.

Aspect 2: The method of Aspect 1, wherein the one or more conditions are associated with the measurement gap configuration.

Aspect 3: The method of any of Aspects 1-2, wherein the one or more conditions include a supported time gap between measurement gap occasions indicated by the measurement gap configuration.

Aspect 4: The method of any of Aspects 1-3, wherein the one or more conditions include a supported time gap between a scheduling communication and a measurement gap occasion indicated by the measurement gap configuration.

Aspect 5: The method of any of Aspects 1-4, wherein the communication indicates one or more aperiodic measurement gap occasions for the measurement gap configuration, the one or more aperiodic measurement gap occasions being associated with a traffic pattern indicated by the assistance information.

Aspect 6: The method of any of Aspects 1-5, wherein the communication indicates a delay factor associated with one or more measurement gap occasions configured by the measurement gap configuration.

Aspect 7: The method of Aspect 6, wherein the delay factor indicates that starting times of the one or more measurement gap occasions are to be delayed by an amount of time.

Aspect 8: The method of Aspect 6, wherein the delay factor indicates that durations of the one or more measurement gap occasions are to be scaled.

Aspect 9: The method of any of Aspects 1-8, further comprising: identifying an event associated with the assistance information, the transmission of the assistance information being associated with identifying the event.

Aspect 10: The method of Aspect 9, wherein identifying the event comprises: receiving configuration information indicating the measurement gap configuration.

Aspect 11: The method of any of Aspects 9-10, wherein identifying the event comprises: identifying that a measurement value of a serving cell does not satisfy a threshold.

Aspect 12: The method of Aspect 11, further comprising: transmitting a measurement report indicating the measurement value, the event being associated with the transmission of the measurement report.

Aspect 13: The method of any of Aspects 9-12, wherein identifying the event comprises: identifying a measurement gap occasion associated with the measurement gap configuration, the event being associated with causing the transmission of the assistance information to occur before the measurement gap occasion.

Aspect 14: The method of any of Aspects 9-13, wherein identifying the event comprises: receiving a medium access control communication indicating that the UE is to transmit the assistance information.

Aspect 15: The method of any of Aspects 1-14, wherein the status information includes a buffer status report.

Aspect 16: The method of any of Aspects 1-15, wherein the status information includes a delay status report.

Aspect 17: The method of any of Aspects 1-16, wherein the status information includes a data priority indicator of traffic associated with the UE.

Aspect 18: The method of any of Aspects 1-17, wherein the status information includes an estimated time of arrival of traffic associated with the UE.

Aspect 19: The method of any of Aspects 1-18, wherein the status information includes an energy status report.

Aspect 20: The method of any of Aspects 1-19, wherein the status information includes an indication of a speed of the UE.

Aspect 21: The method of any of Aspects 1-20, wherein the assistance information includes an indication to delay one or more measurement gap occasions associated with the measurement gap configuration.

Aspect 22: The method of any of Aspects 1-21, wherein the communication indicates an activation or deactivation of one or more measurement gap occasions associated with the measurement gap configuration.

Aspect 23: The method of any of Aspects 1-22, wherein the communication indicates a delay associated with starting times of one or more measurement gap occasions associated with the measurement gap configuration.

Aspect 24: The method of any of Aspects 1-23, wherein the communication indicates a modification of the measurement gap configuration, and the method further comprising: receiving data associated with a traffic flow; and performing, during a duration of the traffic flow, one or more measurements during a measurement gap in accordance with the modification of the measurement gap configuration.

Aspect 25: The method of Aspect 24, wherein the traffic flow is an extended reality (XR) traffic flow.

Aspect 26: A method of wireless communication performed at a network node, comprising: receiving assistance information associated with a user equipment (UE), the assistance information being associated with measurement gaps, and the assistance information indicating at least one of one or more conditions or status information; and transmitting a communication, for the UE, associated with a measurement gap configuration, the communication being associated with the assistance information.

Aspect 27: The method of Aspect 26, wherein the one or more conditions are associated with the measurement gap configuration.

Aspect 28: The method of any of Aspects 26-27, wherein the one or more conditions include a supported time gap between measurement gap occasions indicated by the measurement gap configuration.

Aspect 29: The method of any of Aspects 26-28, wherein the one or more conditions include a supported time gap between a scheduling communication and a measurement gap occasion indicated by the measurement gap configuration.

Aspect 30: The method of any of Aspects 26-29, wherein the communication indicates one or more aperiodic measurement gap occasions for the measurement gap configuration, the one or more aperiodic measurement gap occasions being associated with a traffic pattern indicated by the assistance information.

Aspect 31: The method of any of Aspects 26-30, wherein the communication indicates a delay factor associated with one or more measurement gap occasions configured by the measurement gap configuration.

Aspect 32: The method of Aspect 31, wherein the delay factor indicates that starting times of the one or more measurement gap occasions are to be delayed by an amount of time.

Aspect 33: The method of Aspect 31, wherein the delay factor indicates that durations of the one or more measurement gap occasions are to be scaled.

Aspect 34: The method of any of Aspects 26-33, wherein the reception of the assistance information is associated with an event.

Aspect 35: The method of Aspect 34, further comprising: transmitting configuration information indicating the measurement gap configuration, the event being associated with the transmission of the configuration information.

Aspect 36: The method of any of Aspects 34-35, wherein the event is associated with a measurement value of a serving cell does not satisfy a threshold.

Aspect 37: The method of Aspect 36, further comprising: receiving a measurement report indicating the measurement value, the event being associated with the reception of the measurement report.

Aspect 38: The method of any of Aspects 34-37, wherein the event is associated with a timing of a measurement gap occasion associated with the measurement gap configuration, the event being associated with causing the reception of the assistance information to occur before the measurement gap occasion.

Aspect 39: The method of any of Aspects 34-38, further comprising: transmitting a medium access control communication indicating that the UE is to transmit the assistance information, the event being associated with the transmission of the medium access control communication.

Aspect 40: The method of any of Aspects 26-39, wherein the status information includes a buffer status report.

Aspect 41: The method of any of Aspects 26-40, wherein the status information includes a delay status report.

Aspect 42: The method of any of Aspects 26-41, wherein the status information includes a data priority indicator of traffic associated with the UE.

Aspect 43: The method of any of Aspects 26-42, wherein the status information includes an estimated time of arrival of traffic associated with the UE.

Aspect 44: The method of any of Aspects 26-43, wherein the status information includes an energy status report.

Aspect 45: The method of any of Aspects 26-44, wherein the status information includes an indication of a speed of the UE.

Aspect 46: The method of any of Aspects 26-45, wherein the assistance information includes an indication to delay one or more measurement gap occasions associated with the measurement gap configuration.

Aspect 47: The method of any of Aspects 26-46, wherein the communication indicates an activation or deactivation of one or more measurement gap occasions associated with the measurement gap configuration.

Aspect 48: The method of any of Aspects 26-47, wherein the communication indicates a delay associated with starting times of one or more measurement gap occasions associated with the measurement gap configuration.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, and/or measuring, among other examples. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, and/or measuring, among other examples. Also, “identifying” can include receiving (such as receiving information or receiving an indication), accessing (such as accessing data stored in memory), transmitting (such as transmitting information) among other examples. Also, “identifying” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit, to a network node, assistance information associated with measurement gaps, the assistance information indicating at least one of one or more conditions or status information; and
receive, from the network node, a communication associated with a measurement gap configuration, the communication being associated with the assistance information.

2. The apparatus of claim 1, wherein the one or more conditions are associated with the measurement gap configuration.

3. The apparatus of claim 1, wherein the one or more conditions include a supported time gap between a scheduling communication and a measurement gap occasion indicated by the measurement gap configuration.

4. The apparatus of claim 1, wherein the communication indicates a delay factor associated with one or more measurement gap occasions configured by the measurement gap configuration.

5. The apparatus of claim 4, wherein the delay factor indicates that durations of the one or more measurement gap occasions are to be scaled.

6. The apparatus of claim 1, wherein at least one processor of the one or more processors is further configured to cause the UE to:
identify an event associated with the assistance information, the transmission of the assistance information being associated with identifying the event.

7. The apparatus of claim 6, wherein at least one processor of the one or more processors, to cause the UE to identify the event, is configured to cause the UE to:
identify that a measurement value of a serving cell does not satisfy a threshold.

8. The apparatus of claim 6, wherein at least one processor of the one or more processors, to cause the UE to identify the event, is configured to cause the UE to:
identify a measurement gap occasion associated with the measurement gap configuration, the event being associated with causing the transmission of the assistance information to occur before the measurement gap occasion.

9. The apparatus of claim 6, wherein at least one processor of the one or more processors, to cause the UE to identify the event, is configured to cause the UE to:
receive a medium access control communication indicating that the UE is to transmit the assistance information.

10. The apparatus of claim 1, wherein the status information includes at least one of:
a buffer status report,
a delay status report,
a data priority indicator of traffic associated with the UE,
an estimated time of arrival of traffic associated with the UE,
an energy status report, or
an indication of a speed of the UE.

11. The apparatus of claim 1, wherein the communication indicates an activation or deactivation of one or more measurement gap occasions associated with the measurement gap configuration.

12. The apparatus of claim 1, wherein the communication indicates a delay associated with starting times of one or more measurement gap occasions associated with the measurement gap configuration.

13. An apparatus for wireless communication at a network node, comprising:
one or more memories storing processor readable code; and
one or more processors coupled with the one or more memories, at least one processor of the one or more processors configured to cause the network node to:
receive assistance information associated with a user equipment (UE), the assistance information being associated with measurement gaps, and the assistance information indicating at least one of one or more conditions or status information; and
transmit a communication, for the UE, associated with a measurement gap configuration, the communication being associated with the assistance information.

14. The apparatus of claim 13, wherein the one or more conditions include a supported time gap between measurement gap occasions indicated by the measurement gap configuration.

15. The apparatus of claim 13, wherein the communication indicates one or more aperiodic measurement gap occasions for the measurement gap configuration, the one or more aperiodic measurement gap occasions being associated with a traffic pattern indicated by the assistance information.

16. The apparatus of claim 13, wherein the communication indicates a delay factor associated with one or more measurement gap occasions configured by the measurement gap configuration.

17. The apparatus of claim 16, wherein the delay factor indicates that starting times of the one or more measurement gap occasions are to be delayed by an amount of time.

18. The apparatus of claim 13, wherein the reception of the assistance information is associated with an event.

19. The apparatus of claim 18, wherein at least one processor of the one or more processors are further configured to cause the network node to:
transmit a medium access control communication indicating that the UE is to transmit the assistance information, the event being associated with the transmission of the medium access control communication.

20. A method of wireless communication performed at a user equipment (UE), comprising:
transmitting, to a network node, assistance information associated with measurement gaps, the assistance information indicating at least one of one or more conditions or status information; and
receiving, from the network node, a communication associated with a measurement gap configuration, the communication being associated with the assistance information.

21. The method of claim 20, wherein the one or more conditions include a supported time gap between measurement gap occasions indicated by the measurement gap configuration.

22. The method of claim 20, wherein the communication indicates one or more aperiodic measurement gap occasions for the measurement gap configuration, the one or more aperiodic measurement gap occasions being associated with a traffic pattern indicated by the assistance information.

23. The method of claim 20, wherein the communication indicates a delay factor associated with one or more measurement gap occasions configured by the measurement gap configuration.

24. The method of claim 23, wherein the delay factor indicates that starting times of the one or more measurement gap occasions are to be delayed by an amount of time.

25. The method of claim 20, further comprising:
identifying an event associated with the assistance information, the transmission of the assistance information being associated with identifying the event.

26. The method of claim 25, wherein identifying the event comprises:
identifying that a measurement value of a serving cell does not satisfy a threshold.

27. The method of claim 26, further comprising:
transmitting a measurement report indicating the measurement value, the event being associated with the transmission of the measurement report.

28. The method of claim 20, wherein the assistance information includes an indication to delay one or more measurement gap occasions associated with the measurement gap configuration.

29. A method of wireless communication performed at a network node, comprising:
receiving assistance information associated with a user equipment (UE), the assistance information being associated with measurement gaps, and the assistance information indicating at least one of one or more conditions or status information; and
transmitting a communication, for the UE, associated with a measurement gap configuration, the communication being associated with the assistance information.

30. The method of claim 29, wherein the communication indicates a delay factor associated with one or more measurement gap occasions configured by the measurement gap configuration.
